(19) United States
(12) Patent Application Publication
(10) Pub. No.: US 2024/0338891 A1
(43) Pub. Date: Oct. 10, 2024

(54) APPARATUS AND METHOD FOR VIRTUAL EVENT ELEMENT GENERATION BASED ON AN ACTUAL ACTION OF AN ENTITY

(71) Applicant: Gravystack, Inc., Phoenix, AZ (US)

(72) Inventors: Scott Donnell, Phoenix, AZ (US); Travis Adams, Phoenix, AZ (US); Chad Willardson, Phoenix, AZ (US)

(73) Assignee: Gravystack, Inc., Phoenix, AZ (US)

(21) Appl. No.: 18/131,568

(22) Filed: Apr. 6, 2023

(51) Int. Cl. G06T 17/00; G06F 3/14; G06V 10/70

(52) U.S. Cl. CPC G06T 17/00; G06F 3/14

(57) ABSTRACT

An apparatus for virtual event element generation based on an actual action of an entity, the apparatus includes at least a processor and a memory communicatively connected to the at least a processor, wherein the memory contains instructions configuring the at least a processor to generate a plurality of virtual action data, receive an actual action datum related to an entity, identify at least one virtual action datum from plurality of virtual action data as a function of the actual action datum, and generate a virtual event element associated to the at least one virtual action datum as a function of the actual action datum.

### FIELD OF THE INVENTION

The present invention generally relates to the field of virtual element generation. In particular, the present invention is directed to apparatus and method for virtual event element generation based on an actual action of an entity.

### BACKGROUND

At present, methods related to the generation of virtual elements in virtual events that connect virtual events to real-world activities are underdeveloped. Currently, virtual event element generation only provides rudimentary connections between virtual events and real-world activities, and existing solutions for providing deeper connections between facets of events or activities are severely lacking.

### SUMMARY OF THE DISCLOSURE

In an aspect, a datum and/or virtual event element generation based on an actual action of an entity, the apparatus includes at least a processor and a memory communicatively connected to the at least a processor, wherein the memory contains instructions configuring the at least a processor to generate a plurality of virtual action data, receive an actual action datum related to an entity, identify at least one virtual action datum from plurality of virtual action data as a function of the actual action datum, and generate a virtual event element associated to the at least one virtual action datum as a function of the actual action datum.

In another aspect, a method for virtual event element generation based on an actual action of an entity, the method includes generating, by at least a processor, a plurality of virtual action data, receiving, by the at least a processor, an actual action datum related to an entity, identifying, by the at least a processor, at least one virtual action datum from plurality of virtual action data as a function of the actual action datum, and generating, by the at least a processor, a virtual event element associated to the at least one virtual action datum as a function of the actual action datum.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of an apparatus for virtual event element generation based on an actual action of an entity;

FIG. 2 is a block diagram of an exemplary machine-learning process;

FIG. 3 is a diagram of an exemplary embodiment of neural network;

FIG. 4 is a diagram of an exemplary embodiment of a node of a neural network;

FIG. 5 is a graph illustrating an exemplary relationship between fuzzy sets;

FIG. 6 is a flow diagram illustrating an exemplary method for virtual event element generation based on an actual action of an entity; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and method for virtual event element generation based on an actual action of an entity, the apparatus includes at least a processor and a memory communicatively connected to the at least a processor. The memory contains instructions configure the at least a processor to generate a plurality of virtual action data, receive an actual action datum related to an entity, identify at least one virtual action datum from plurality of virtual action data as a function of the actual action datum, and generate a virtual event element associated to the at least one virtual action datum as a function of the actual action datum.

Aspects of the present disclosure can be used to modify virtual event elements. Aspects of the present disclosure can also be used to generate virtual events from one or more actual event profiles. Exemplary embodiments illustrating aspects of the present disclosure are described below in the context of several specific examples.

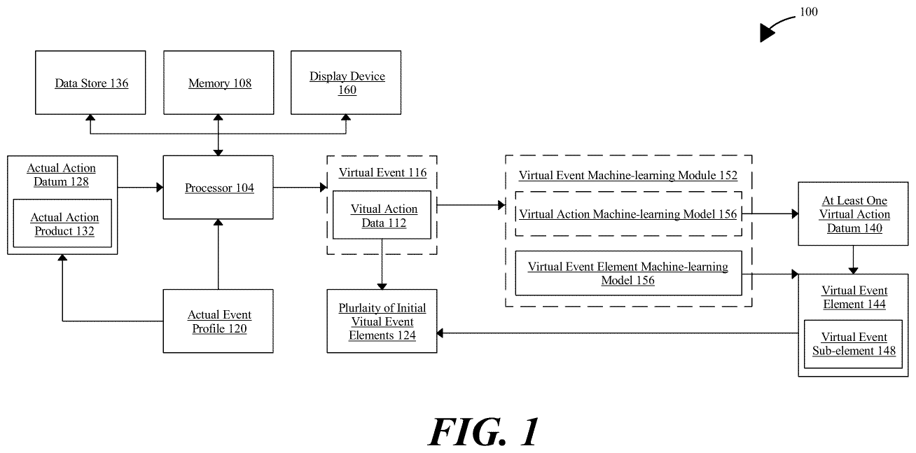

Referring now to FIG. 1, an exemplary embodiment of an apparatus for virtual event element generation based on an actual action of an entity is illustrated. Apparatus 100 includes at least a processor 104 and a memory 108 communicatively connected to the at least a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, as used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 and/or computing device may perform determinations, classification, and/or analysis steps, methods, processes, or the like as described in this disclosure using machine learning processes. A “machine learning process,” as used in this disclosure, is a process that automatedly uses a body of data known as “training data” and/or a “training set” (described further below) to generate an algorithm that will be performed by a computing device/module to produce outputs given data provided as inputs; this is in contrast to a non-machine learning software program where the commands to be executed are determined in advance by a user and written in a programming language. Machine-learning process may utilize supervised, unsupervised, lazy-learning processes and/or neural networks, described further below.

With continued reference to FIG. 1, processor 104 is configured to generate a plurality of virtual action data 112. As used in this disclosure, each “virtual action datum” of plurality of virtual action data 112 is an element of data representing an operation or a set of operations of entity in virtual event 116. As used in this disclosure, a “virtual event” is an event that involves one or more entities participating in a virtual environment. In a non-limiting example, virtual event 116 may include an electronic game, wherein the electronic game may include, without limitation, web-based game, computer game, virtual reality (VR) game, augmented reality (AR) game, and the like thereof. In some embodiments, virtual event 116 may be configured to deliver an event objective for participated entities; for instance, and without limitation, event objective may include improving participated entities' financial literacy. Virtual event 116 may be configured to improve participated entities' ability to understand and effectively use one or more financial skills such as, without limitation, financial management, budgeting, investing, and the like thereof. In a non-limiting example, virtual event 116 may include an educational video game running on the computing device that helps participated entities to learn about finance, expand financial concepts, reinforce financial development, and/or assist participated entities in learning financial skills listed above. As used in this disclosure, an “entity” is an independent and distinct existence such as a legal person. In some cases, an entity may include an individual, a group of individuals, a team, a family, and the like thereof. Continuing with the previous example, an entity may include, without limitation, a user of apparatus 100. Participated entities of virtual event 116 may include children and/or teenagers who are interested in financing. In some cases, each virtual action datum of plurality of virtual action data 112 may include an operation or a set of operations of entity in virtual environment; for instance, and without limitation, establishing a connection between entity and virtual environment to enable access to virtual event 116. In some embodiments, each virtual action datum of plurality of virtual action data 112 may include an operation or a set of operations on virtual event 116 for completing event objective described above. In a non-limiting example, plurality of virtual action data 112 may include a plurality of operations of an entity for learning one or more financial skills in an educational video game, wherein the plurality of operations may include interacting with elements within the educational video game. Elements may include, without limitation, virtual event elements described in further detail below.

With continued reference to FIG. 1, as used in this disclosure, a “virtual environment” is a digital environment which allows entities to interact with it and elements/devices thereof within the virtual environment digitally. In some embodiments, virtual environment may be one of a computer system, computer network, and the like. In a non-limiting example, virtual environment may include a virtual machine. In some embodiments, virtual environment may also include any electronically based elements associated with the virtual environment, as described in this disclosure. In a non-limiting example, virtual environment may include computer programs, data, data stores, and the like thereof. In some cases, virtual environment may be local to processor 104; for instance, and without limitation, virtual environment may be generated and hosted by processor 104 locally in a single device. In other cases, virtual environment may be remote to processor 104; for instance, virtual environment may be connected to the processor 104 by a network. Virtual environment may employ any type of network architecture. For example, and without limitation, virtual environment may employ a peer to peer (P2P) architecture where each computing device in a computing network is connected with every computing device in the network and every computing device acts as a server for the data stored in the computing device. In a further exemplary embodiment, virtual environment may also employ a client server architecture where a computing device is implemented as a central computing device (e.g., server) that is connected to each client computing device and communication is routed through the central computing device. However, the network architecture is not limited thereto. One skilled in the art will recognize the various network architectures that may be employed by the virtual environment. In other embodiments, any network topology may be used. In a non-limiting example, digital environment may employ a mesh topology where a computing device is connected to one or multiple other computing devices using point to point connections. However, the network topology is not limited thereto. One skilled in the art will recognize the various network architectures that may be employed by the virtual environment. Additionally, or alternatively, virtual environment may be shared between plurality of entities. In a non-limiting example, any interaction, modification, or otherwise communication with virtual network initiated by one or more entities, may be visible and/or available to all entities within the same virtual network. Further, virtual environment may be persistent; for instance, and without limitation, virtual environment may be running 24/7. Entities may interact with virtual environment in real time at any given time period.

With continued reference to FIG. 1, in some embodiments, virtual environment may include a cloud environment. As used in this disclosure, a “cloud environment” is a set of systems and/or processes acting together to provide services in a manner that is dissociated with underlaying hardware and/or software within apparatus 100 used for such purpose and includes a cloud. A “cloud,” as described herein, refers to one or more devices (i.e., servers) that are accessed over the network. In some cases, cloud may include Hybrid Cloud, Private Cloud, Public Cloud, Community Cloud, any cloud defined by National Institute of Standards and Technology (NIST), and the like thereof. In some embodiments, cloud environment may include implementation of cloud computing. As used in this disclosure, “cloud computing” is an on-demand delivery of information technology (IT) resources within a network through the internet, without direct active management by entities. In a non-limiting example, virtual environment may include cloud gaming platform. As used in this disclosure, “cloud gaming,” also known as gaming-as-a-service is a cloud computing service model which runs electronic games (i.e., virtual event 116) on remote servers, making electronic games remotely available to entities. In some embodiments, virtual event 116 may be delivered to one or more entities in a continuous manner from one or more clouds described above within virtual environment. Entities may participate in such virtual event 116 remotely from one or more clouds. In a non-limiting example, virtual event 116 may be stored and/or executed remotely on a provider's dedicated hardware, and/or streamed as video to participated entities' device via a client software, wherein the client software may be configured to handle inputs from participated entities; for instance, and without limitation, client software may receive inputs from participated entities and/or send received inputs to the server and executed in virtual event 116. Additionally, or alternatively, virtual environment may include one or more data storages. For example, and without limitation, virtual environment may include one or more data stores described in further detail below.

With continued reference to FIG. 1, in some embodiments, generating plurality of virtual action data 112 may include receiving an actual event profile 120 and generating the plurality of virtual action data 112 as a function of the actual event profile 120. As used in this disclosure, an “actual event profile” is a collection of data related to an actual event. An “actual event,” for the purpose of this disclosure, is a real-world event that involves one or more entities. In some embodiments, actual event may include one or more entities interacting physically at a physical location. In some cases, data related to an actual event may include, without limitation, information regarding to descriptions and/or objectives of the actual event, physical objects used in the actual event, rules regulating the actual event, and/or the like thereof. In a non-limiting example, actual event may include real-world activity related to finance such as buying/selling items, depositing/withdrawing money, collecting/applying coupons, planning budget, reconciling receipts, bookkeeping, and the like thereof. Data related to actual event may include data related to physical objects used in actual event; for instance, and without limitation, merchandises, debit cards/credit cards, coupons, receipts, and the like thereof. Data related to actual event may further include data related to rules regulating actual events; for instance, and without limitation, transaction process, coupon validation, receipt formats, bookkeeping process, and the like thereof. Generating plurality of virtual action data 112 may include digitalizing actual event into virtual event 116 using processor 104 described above. Virtual event 116 may be configured to create as similar an experience as possible to actual event. In a non-limiting example, digitalizing actual event may include digitalizing data related to actual event; for instance, and without limitation, processor 104 may be configured to receive an actual event profile containing an account number and a routing number of entity's saving account and storing the account number and the routing number in virtual event 116 and/or virtual environment using a data structure.

With continued reference to FIG. 1, in some embodiments, plurality of virtual action data 112 may be associated with a plurality of initial virtual event elements 124. As used in this disclosure, an “initial virtual event element” is a first virtual event element in a temporal order. A “virtual event element,” for the purpose of this disclosure, is elements that make up virtual event 116. In some embodiments, without limitation, virtual event element may include mechanics of virtual event 116. In a non-limiting example, virtual event element may include points, badges, levels, and the like thereof. Entity participating in virtual event 116 may be associated with a plurality of virtual event elements; for instance, and without limitation, player level, player rank, player collections, and the like thereof. In another non-limiting examples, virtual event element may include in-game currency such as, without limitation, tokens, coins, gems, and/or the like that can be collected/generated within virtual event 116 used for exchanging with other virtual event elements such as, without limitation, game props. In some embodiments, without limitation, virtual event element may include digital representation of things such as, without limitation, entities, real-world objects, and the like thereof. In a non-limiting example, generating plurality of virtual action data may include digitalizing actual event as described above, wherein digitalizing actual event may include digitalizing one or more objects from actual event; for instance, and without limitation, digitalizing a coupon may include generating a universally unique identifier (UUID) representing the coupon within virtual event 116 and/or virtual environment. Such digitalized coupon may be a virtual event element of a virtual event which uses digitalized coupon. In another non-limiting example, virtual event element may include a virtual representation of an entity; for instance, and without limitation, virtual event element may include a virtual avatar, wherein the virtual avatar may be consistent with any virtual avatar model described in U.S. patent application Ser. No. 17/872,135, filed on Jul. 25, 2022, and titled “APPARATUS AND METHOD FOR GENERATING A VIRTUAL AVATAR,” the entirety of which is incorporated by reference herein. Plurality of initial virtual event elements 124 may include a plurality of placeholder elements initialized when virtual event 116 is generated. In some cases, processor 104 may be configured to generate plurality of initial virtual event elements 124 when one or more entities participate in virtual event 116. In a non-limiting example, plurality of initial virtual event element 124 may include a plurality of placeholder elements such as, without limitation, default player level, default player in-game currency, empty player collections, and the like thereof. Additionally, or alternatively, plurality of initial virtual event elements 124 may be generated as a function of plurality of virtual action data 112; for instance, and without limitation, plurality of virtual action data 112 may include a virtual action datum which includes an operation which introducing a new financial concept into virtual event 116. Processor 104 may be configured to generate an initial virtual event element representing entity's understanding of the new financial concept, wherein the initial virtual event element may include a value 0 and/or percentage 0%. Such initial virtual event element may only associate with that particular virtual action datum.

With continued reference to FIG. 1, processor 104 is configured to receive an actual action datum 128 related to an entity. As used in this disclosure, an “actual action datum” is an element of data representing an operation or a set of operations of entity in actual event in a physical environment; in other words, an actual action datum is an element of data describing a “real-world” event that is taking place outside of a game or other virtual environment. In some embodiments, actual action datum 128 may be received from an actual event participated by the entity. Actual event may include any actual event described in this disclosure. In some embodiments, actual action datum 128 may include physical movements/locations of entity; for instance, without limitation, actual action datum 128 may include walking, running, jumping, and/or any exercise/actions performed by entity physically. In some embodiments, actual action datum 128 may include user input produced physically by entity. In a non-limiting example, actual action datum 128 may include user input from entity such as, without limitation, written text, captured pictures, recorded audio/video, and/or the like thereof. In some cases, actual action datum may be received from actual event profile described above. In a non-limiting example, actual action datum 128 may include behavioral data, wherein the behavioral data may be consistent with any behavioral data set described in U.S. patent application Ser. No. 17/872,950, filed on Jul. 25, 2022, and titled “APPARATUS AND METHODS FOR ANALYZING DEFICIENCIES,” the entirety of which is incorporated by reference herein. Additionally, or alternatively, actual action datum 128 may include an actual action product 132. As used in this disclosure, an “actual action product” is an element of data related to a result, consequence, or otherwise a product derived from actual action datum 128. In some embodiments, actual action product 132 may be determined by processor 104 as a function of actual action datum 128. In a non-limiting example, actual action datum may include entity taking a financial training course. Actual action datum may include one or more actual action products such as, without limitation, grades, certificates, course outcomes, and the like thereof. In another non-limiting example, an actual action datum 128 may include a tracking of entity's movement, wherein the actual action datum 128 may include one or more actual action products such as, without limitation, entity displacement, travel distance, movement speed, total time, and the like thereof. In other non-limiting examples, an actual action datum 128 may include history datum, wherein the actual action datum 128 may include an actual action product 132 such as, without limitation, a pattern datum. History datum and pattern datum may be consistent with any history datum and pattern datum described in U.S. patent application Ser. No. 17/872,466, filed on Jul. 25, 2022, and titled “AN APPARATUS FOR PRODUCING A TARGET STRATEGY AND A METHOD FOR ITS USE,” the entirety of which is incorporated by reference herein.

With continued reference to FIG. 1, in an embodiment, actual action datum 128 may be received from one or more device. As a non-limiting example, a device may include smart mobile devices such as, without limitation, tablet, laptop, smart phone, and the like. In some embodiments, actual action datum 128 may include wearable device data that tracks an entity's real-world activities. As used in the current disclosure, a “wearable device” is a computing device that is designed to be worn on a user's body or clothing. The wearable device may detect wearable device data. In embodiments, a wearable device may include a smart watch, smart ring, fitness tracking device, and the like. As used in the current disclosure, “wearable device data” is data collected by a wearable device. Wearable device data may include data and associated analysis corresponding to, for instance and without limitation, accelerometer data, pedometer data, gyroscope data, electrocardiography (ECG) data, electrooculography (EOG) data, bioimpedance data, blood pressure and heart rate monitoring, oxygenation data, biosensors, fitness trackers, force monitors, motion sensors, video and voice capture data, social media platform data, and the like. In some embodiments, actual action datum 128 may include data related to internet activity of entity. As used in this disclosure, “internet activity” is any activity that is done through the internet in virtual environment. As a non-limiting example, internet activity may include content browsing with a phone, content browsing with a laptop, online-shopping using a phone, internet surfing using a phone, and the like. Additionally, or alternatively, at least a processor 104 may receive actual action datum 128 from augmented reality. Additional disclosure on augmented reality may be disclosed in U.S. patent application Ser. No. 17/872,630, filed on Jul. 25, 2022, and titled “AN APPARATUS FOR GENERATING AN AUGMENTED REALITY,” the entirety of which is incorporated by reference herein.

With continued reference to FIG. 1, in some embodiments, at least a processor 104 may use optical character recognition (OCR) to process actual action datum into machine-readable text. Optical character recognition may include automatic conversion of images of written, such as without limitation typed, handwritten or printed text, into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

With continued reference to FIG. 1, in some cases, OCR may be an “offline” process, which analyses a static document or image frame. In some cases, handwriting movement analysis can be used as input to a handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

With continued reference to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform, such as, without limitation, homography or affine transform, to image component to align text. In some cases, a de-speckle process may include removing positive and negative spots and/or smoothing edges. In some cases, a binarization process may include converting an image from color or greyscale to black-and-white, such as without limitation a binary image. Binarization may be performed as a simple way of separating text or any other desired image component from a background of image component. In some cases, binarization may be required for example if an employed OCR algorithm only works on binary images. In some cases. A line removal process may include removal of non-glyph or non-character imagery, such as without limitation boxes and lines. In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

With continued reference to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

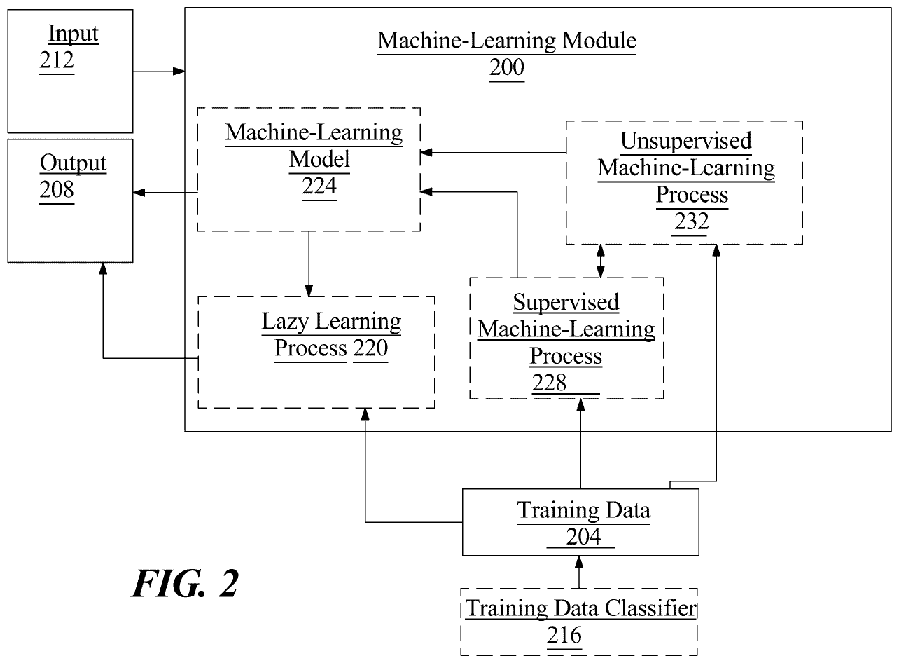

With continued reference to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, a machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 2-5. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

With continued reference to FIG. 1, in some cases, OCR may employ a two-pass approach to character recognition. Second pass may include adaptive recognition and use letter shapes recognized with high confidence on a first pass to recognize better remaining letters on the second pass. In some cases, a two-pass approach may be advantageous for unusual fonts or low-quality image components where visual verbal content may be distorted. Another exemplary OCR software tool may include OCRopus. OCRopus development is led by German Research Centre for Artificial Intelligence in Kaiserslautern, Germany. In some cases, OCR software may employ neural networks, for example neural networks as described in reference to FIGS. 2-4.

With continued reference to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, in some embodiments, processor 104 may generate a chatbot. A “chatbot” as used in this disclosure is a program that communicates semantic information between an individual and a computing device. A chatbot may be communicative with processor 104. Processor 104 may be configured to operate a chatbot. In some cases, a chatbot may be local to processor 104. Alternatively, or additionally, in some cases, a chatbot may be remote to processor 104 and communicative with processor 104, by way of one or more networks, such as without limitation the internet. Alternatively, or additionally, a chatbot may communicate with processor 104 using telephonic devices and networks, such as without limitation fax machines, short message service (SMS), or multimedia message service (MMS). In some embodiments, a chatbot may communicate with processor 104 using text-based communication, for example without limitation using a character encoding protocol, such as American Standard for Information Interchange (ASCII). Processor 104 may interface with a chatbot, by way of at least a submission from a user, such as through the chatbot, and a response from the chatbot. In many cases, one or both of submissions and responses may be text-based communication. Alternatively, or additionally, in some cases, one or both of submissions and responses may be audio-based communication.

Continuing in reference to FIG. 1, a submission once received by processor 104 operating a chatbot, may be processed by processor 104. In some embodiments, processor 104 may process a submission using one or more keyword recognition, pattern matching, and natural language processing, machine learning models, and the like. In some embodiments, processor 104 may employ real-time learning with evolutionary algorithms. In some cases, processor 104 may retrieve a pre-prepared response from a storage component, based upon a submission. Alternatively, or additionally, in some embodiments, processor 104 may communicate a response without first receiving a submission, which may initiate a conversation. In some cases, processor 104 may communicate an inquiry to a chatbot. Processor 104 may be configured to process an answer to the inquiry in a following submission from a chatbot. In some cases, an answer to an inquiry present within a submission from an entity through a chatbot may be used by processor 104 as an input to another function, for example without limitation, actual action datum 128 and/or actual action product 132.

With continued reference to FIG. 1, processor 104 may process actual action datum 128 such as without limitation, textual user input from entity, and/or determine actual action product 132 using a language processing module. Language processing module may include any hardware and/or software module. Language processing module may be configured to extract, from one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to FIG. 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or processor 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

Still referring to FIG. 1, in some embodiments, processor 104 may utilize an automatic speech recognition model to process actual action datum 128, such as without limitation, voice user input from entity, and/or determine actual action product 132. An automatic speech recognition may require training (i.e., enrollment). In some cases, training an automatic speech recognition model may require an individual speaker to read text or isolated vocabulary. In some cases, a solicitation video may include an audio component having an audible verbal content, the contents of which are known a priori by processor 104. Processor 104 may then train an automatic speech recognition model according to training data which includes audible verbal content correlated to known content. In this way, processor 104 may analyze a person's specific voice and train an automatic speech recognition model to the person's speech, resulting in increased accuracy. Alternatively, or additionally, in some cases, processor 104 may include an automatic speech recognition model that is speaker-independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, processor 104 may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include a subject. For example, a subject may speak within solicitation video, but others may speak as well.

Still referring to FIG. 1, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMIs) may include statistical models that output a sequence of symbols or quantities. HMIs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMIs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis, or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimates of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow computing device 104 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

Still referring to FIG. 1, in some embodiments, an automatic speech recognition process may include a neural network. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases. Neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition. Processor 104 may utilize an automatic speech recognition process to determine one or more voice inputs of actual action datum. For instance, and without limitation, a user may say the phrase “use coupon x” to which processor 104 may utilize an automatic speech recognition process and search for coupon x within virtual event 116 and/or virtual environment. Processor 104 may then determine an actual action product which includes a deduction specified by coupon x if entity has coupon x in virtual event 116 and/or virtual environment.

With continued reference to FIG. 1, any data described in this disclosure such as, without limitation, virtual event 116, plurality of virtual action data 112, actual event profile 120, plurality of initial virtual event elements 124, actual action datum 128, actual action product 132, and the like thereof may be received and/or stored in a data store 136 such as, without a limitation, a database. In some cases, data store 136 may be disposed in virtual environment described above. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, processor 104 is configured to identify at least one virtual action datum 140 from plurality of virtual action data 112 as a function of actual action datum 128. As used in this disclosure, an “at least one virtual action datum” is a virtual action datum of plurality of virtual action data 112 that matches a given actual action datum 128. In a non-limiting example, at least one virtual action datum 140 may include one or more operations that matches with one or more operations within actual action datum 128 described above. Identifying at least one virtual action datum 140 may include determining, by processor 104, an action similarity between each virtual action datum of plurality of virtual action data 112 and actual action datum 128. As used in this disclosure, an “action similarity” is a value describing how similar two actions or operations and elements thereof are. In some cases, at least one virtual action datum 140 may include a maximum action similarity among plurality of virtual action data 112. In some embodiments, at least one virtual action datum 140 of a virtual event 116 may include one or more operations that achieves same or similar event objectives as compares to operations within actual action datum 128 received from an actual event, wherein the virtual event 116 may be generated based on the actual event using processing step described above in this disclosure. In some embodiments, at least one virtual action datum 140 may include one or more operations of virtual representation of actual objects specified in actual action datum 128 in virtual event 116. In a non-limiting example, a virtual action datum containing an action of exchanging a game prop in virtual event 116 may be similar to an actual action datum 128 containing an action of buying a merchandise at a store in real-world. In some cases, processor 104 may be configured to determine action similarity between virtual action datum and actual action datum using distance functions, such as, without limitation L2 norm, Euclidean distance, squared Euclidean distance, Canberra distance, Chebyshev distance, Minkowski distance, Cosine distance, Pearson correlation distance, spearman correlation, Mahala Nobis distance, standardized Euclidean distance, Chi-square distance, Jensen-Shannon distance, Levenshtein distance, Dice distance, and the like thereof. Processor 104 may be further configured to select a virtual action datum with maximum action similarity (or otherwise minimum action dissimilarity) as at least one virtual action datum 140. Additionally, or alternatively, processor 104 may identify at least one virtual action datum 140 using a using a lookup table. A “lookup table,” for the purposes of this disclosure, is an array of data that maps input values to output values. A lookup table may be used to replace a runtime computation with an array indexing operation. In a non-limiting example, a virtual action datum lookup table may be able to correlate virtual event 116 to one or more actual event profiles 120. In another non-limiting example, a virtual action datum lookup table may be able to correlate virtual event datum to one or more actual event datums 128. Processor 104 may be configured to “lookup” one or more actual event profiles or actual action data in order to find a corresponding virtual action datum.

With continued reference to FIG. 1, processor 104 may use a machine learning module, such as virtual event machine-learning module 144, to implement one or more algorithms or generate one or more machine-learning models, such as virtual action machine-learning model 148, to determine at least one virtual action datum 140. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories/values of data elements. Exemplary inputs and outputs may come from data store 136, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories or values of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Virtual event machine-learning module 144 may be used to generate virtual action machine-learning model 148 and/or any other machine learning model, such as virtual event element machine-learning model 152, and the like described below, using training data. Virtual action machine-learning model 148 may be trained by correlated inputs and outputs of training data. Training data may be data sets that have already been converted from raw data whether manually, by machine, or any other method. Training data may include previous outputs such that virtual action machine-learning model 148 iteratively produces outputs. Virtual action machine-learning model 148 using a machine-learning process may output converted data based on input of training data. In an embodiment, identifying at least one virtual action datum 140 may include determining at least one virtual action datum 140 from plurality of virtual action data 112 based on actual action datum 128 using a machine learning model, such as virtual action machine-learning model 148 generated by virtual event machine-learning module 144. Virtual action machine-learning model 148 may be trained by virtual action training data, wherein the virtual action training data may include a plurality of actual action data as input correlated to a plurality of virtual action data as output. For example, and without limitation, virtual action training data may be used to show a particular virtual action datum that is most similar to an actual action datum. Identifying at least one virtual action datum 140 using a machine-learning model may further include training a virtual action machine-learning model 148 as a function of virtual action training data. Further, identifying at least one virtual action datum 140 using a machine-learning model may also include determining at least one virtual action datum 140 using trained virtual action machine-learning model 148.

With continued reference to FIG. 1, processor 104 is configured to generate a virtual event element 156 associated to at least one virtual action datum 140 as a function of the actual action datum 128. Virtual event element 156 may include any virtual event element described above in this disclosure. In a non-limiting example, generating virtual event element 156 may include generating virtual event element 156 as a function of actual action product 132 within actual action datum 128. Processor 104 may be configured to convert actual action product 132 to virtual event element 156; for instance, and without limitation, processor 104 may generate a visual representation of actual action product 132 in virtual event 116. In a non-limiting example, processor 104 may generate a digital certificate (i.e., visual event element 156) based on entity's grade (i.e., actual action product 132) from taking a financial training course (i.e., actual action datum 128). In some embodiments, virtual event element 156 may include a virtual event sub-element 160. As used in this disclosure, a “virtual event sub-element” is a subordinate or secondary virtual event element of virtual event element 156. For instance, and without limitation, virtual event element 156 may include a main quest in virtual event 116, and virtual event sub-element 160 may include a side quest related to the main quest in virtual event 116. In some cases, main quest may be a virtualization of an actual event, while side quest related to main quest may be a virtualization of a single step, an action, or otherwise an operation within the actual event. Additionally, or alternatively, virtual event element 156 may include existing virtual event element. In a non-limiting example, processor 104 may be configured to modify at least one initial virtual event element of plurality of initial virtual event elements 124 as a function of virtual event element 156; for instance, and without limitation, virtual event element 156 may include a plurality of collectable tokens such as, without limitation, points, experiences, in-game currency, and the like thereof. Such virtual event element 156 may be combined with corresponding initial virtual event element within plurality of initial virtual event elements 124. Combining virtual event element 156 with corresponding initial virtual event element may include combining values represented by virtual event elements using basic calculation process such as, without limitation, addition, subtraction, multiplication, division, and the like thereof. In other cases, virtual event element 156 may replace one or more initial virtual event elements in virtual event 116. Further, generating the virtual event element 156 using a machine learning model may include receiving virtual event element training data. In an embodiment, virtual event element training data may include a plurality of actual action data that are each correlated to one of a plurality of virtual event elements. For example, virtual element training data may be used to show plurality of actual action data may indicate a particular virtual event element 156 in virtual event 116. Generating virtual event element 156 using a machine learning model may further include training virtual event element machine-learning model 152 as a function of virtual event element training data. Further, generating virtual event element 156 using a machine learning model may also include generating virtual event element 156 using trained virtual event element machine-learning model 160.

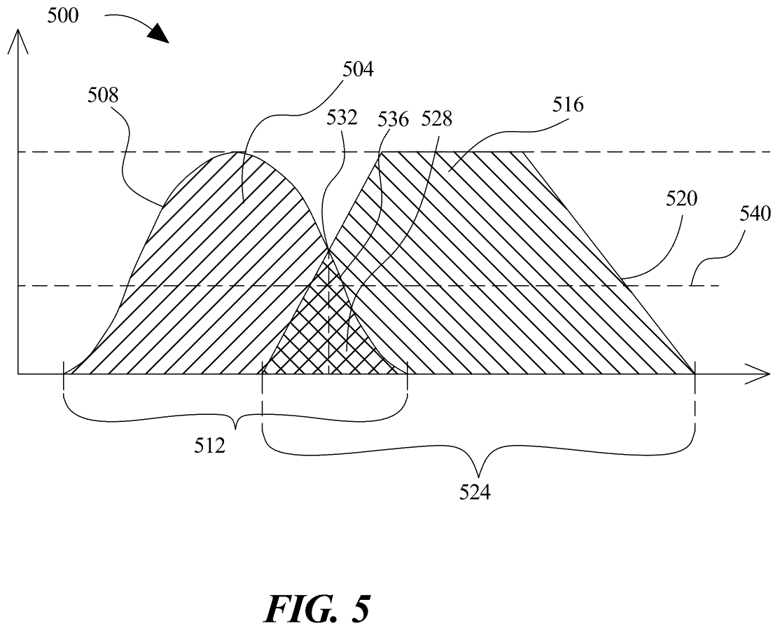

With continued reference to FIG. 1, in some embodiments, generating virtual event element 156 using a rule-based engine. Rule-based engine may include a virtual event element rule 132. As used in this disclosure, a “rule-based engine” is a system that executes one or more rules such as, without limitation, virtual event element rule, in a runtime production environment. As used in this disclosure, a “virtual event element rule” is a pair including a set of conditions and a set of actions, wherein each condition within the set of conditions is a representation of a fact, an antecedent, or otherwise a pattern, and each action within the set of actions is a representation of a consequent. In a non-limiting example, virtual event element rule may include a condition of “entity completing a quest” pair with an action of “gain x points.” In some embodiments, rule-based engine may execute one or more virtual event element rules on existing virtual event elements such as, without limitation, plurality of initial virtual event elements 124, if any conditions within one or more virtual event element rules are met. In a non-limiting example, condition may be triggered by at least one virtual action datum 140 identified by actual action datum 128 as described above. In some embodiments, virtual event element rules may be stored in data store 136. In a non-limiting example, rule-based engine may include a virtual event element rule, wherein the virtual event element rule may include a condition of “successfully use at least a coupon in a transaction” pair within an action of “unlock entity achievement y.” Virtual event 116 may include a plurality of entity achievements (i.e., plurality of initial virtual event elements 124) when virtual event 116 is generated, wherein each entity achievement is a challenge in virtual event 116. Processor 104 may modify the status of entity achievement y from “locked” to “unlocked” when processor 104 receives an actual action datum including an action that satisfying such condition from the entity. Additionally, or alternatively, rule-based engine 128 may include an inference engine for determine a match of virtual event element rule, where virtual action data and/or actual action data may be represented as values and/or fuzzy sets for linguistic variables measuring the same, as described in more detail in FIG. 5. Inference engine may use one or more fuzzy inferencing rules, as described below in FIG. 5, to output one or more linguistic variable values and/or defuzzified values indicating match of virtual event element rule.

With continued reference to FIG. 1, processor 104 may be further configured to display virtual event element 144 to entity through a display device 164. A “display device” as used in this disclosure, is a device having a screen. Display device 164 may include, but is not limited to, VR headsets, monitors, smartphones, laptops, mixed-reality headsets, smart glasses, and the like. In some embodiments, apparatus 100 may be connected to display device 164 through a wired and/or wireless connection. In some embodiments, apparatus 100 may be connected to display device 164 locally. In other embodiments, processor 104 may communicate virtual event 116 and/or virtual event element 156 to display device 164 through one or more computing devices, networks, and the like. In a non-limiting example, processor 104 may display virtual event 116 through a graphical user interface (GUI). A GUI may include a two-dimensional GUI that may be displayed on a monitor, laptop, and/or other screen. A GUI may include a three-dimensional GUI that may be displayed within a virtual reality, augmented reality, and the like. A GUI may include one or more sliders, buttons, drop-down menus, tables, and the like, which may be responsive to plurality of virtual action data 112. Plurality of virtual action data 112 may be associated with plurality of virtual event elements.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. Machine-learning process may use training data 204 to generate an algorithm that will be performed by processor 104/module to produce outputs 208 given data provided as inputs 212; this is in contrast to a non-machine learning software program where the commands to be executed are determined in advance by a user and written in a programming language. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs and outputs as described above in this disclosure, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

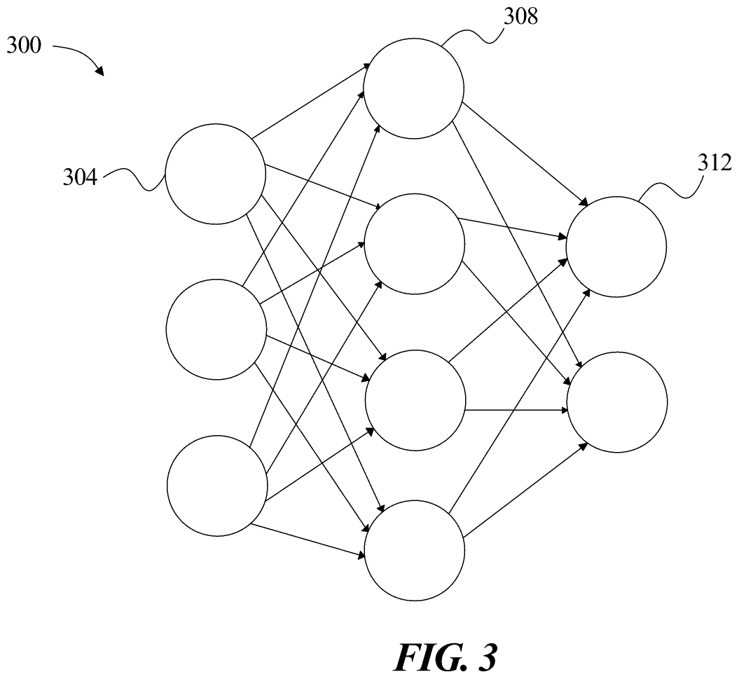

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

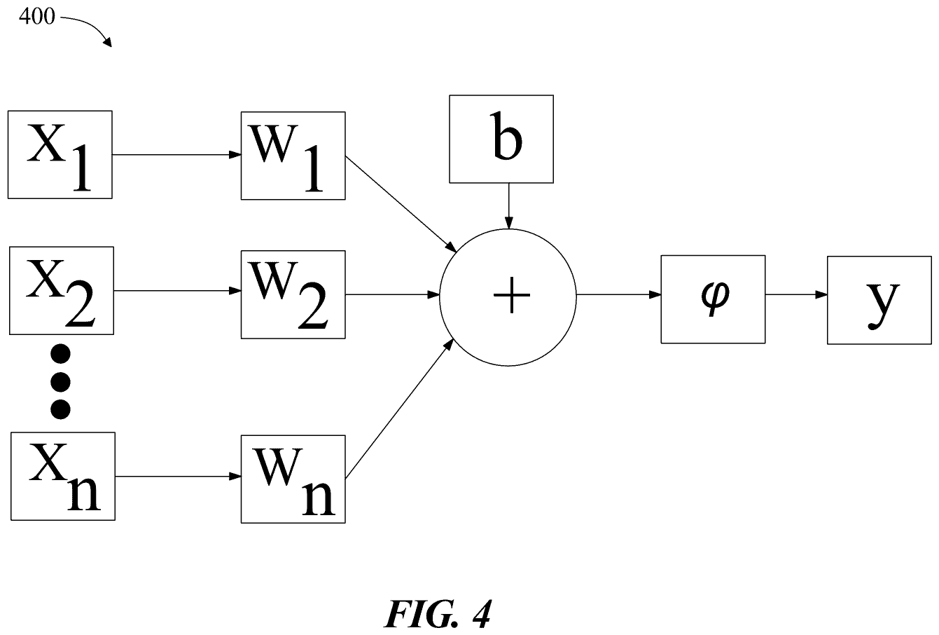

Referring now to FIG. 4, an exemplary embodiment of a node of a neural network is illustrated. A node may include, without limitation, a plurality of inputs xi that may receive numerical values from inputs to a neural network containing the node and/or from other nodes. Node may perform a weighted sum of inputs using weights wi that are multiplied by respective inputs xi. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight.

Referring now to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

With continued reference to FIG. 5, first fuzzy set 504 may represent any value or combination of values as described above, including output from one or more machine-learning models and/or a predetermined class. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively or additionally, a single value of first and/or second fuzzy set may be located at a locus 676 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models and/or a predetermined class for combination to occur as described above. Alternatively or additionally, each threshold may be tuned by a machine-learning and/or statistical process, for instance and without limitation as described in further detail below.

With continued reference to FIG. 5, in an embodiment, a degree of match between fuzzy sets may be used to classify any data described as classified above. Where multiple fuzzy matches are performed, degrees of match for each respective fuzzy set may be computed and aggregated through, for instance, addition, averaging, or the like, to determine an overall degree of match.

With continued reference to FIG. 5, in an embodiment, an element of data may be compared to multiple fuzzy sets. For instance, the element of data may be represented by a fuzzy set that is compared to each of the multiple fuzzy sets representing, e.g., values of a linguistic variable; and a degree of overlap exceeding a threshold between the datum-linked fuzzy set and any of the multiple fuzzy sets may cause computing device to classify the datum as belonging to each such categorization. Machine-learning methods as described throughout may, in a non-limiting example, generate coefficients used in fuzzy set equations as described above, such as without limitation x, c, and σ of a Gaussian set as described above, as outputs of machine-learning methods.

With continued reference to FIG. 5, a computing device may use a logic comparison program, such as, but not limited to, a fuzzy logic model to determine an output and/or response. An output and/or response may include, but is not limited to low, medium, advanced, superior, good, bad, and the like; each such output and/or response may be represented as a value for a linguistic variable representing output and/or response or in other words a fuzzy set as described above that corresponds to a degree of completion as calculated using any statistical, machine-learning, or other method that may occur to a person skilled in the art upon reviewing the entirety of this disclosure.

With continued reference to FIG. 5, an inference engine may be implemented according to input and/or output membership functions and/or linguistic variables. For instance, a first linguistic variable may represent a first measurable value pertaining to an element being input to the inferencing system while a second membership function may indicate a degree and/or category of one or more other attributes and/or values that may be associated with a user. Continuing the example, an output linguistic variable may represent, without limitation, a value representing a strength and/or deficiency. An inference engine may combine rules the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T (a, b)=T (b, a)), monotonicity: (T (a, b)≤T (c, d) if a≤c and b≤d), (associativity: T (a, T (b, c))=T (T (a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

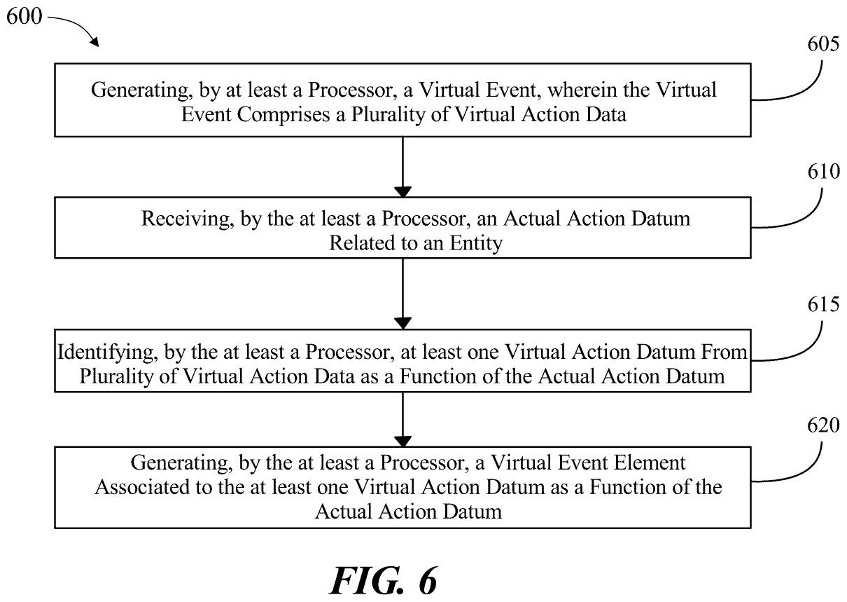

Now referring to FIG. 6, an exemplary embodiment of method 600 for virtual event element generation based on an actual action of an entity is illustrated. Method 600 includes a step 605 of generating, by at least a processor, a plurality of virtual action data. This may be implemented, without limitation, as described above in reference to FIGS. 1-5. In some embodiments, generating the plurality of virtual action data may include receiving an actual event profile and generating the plurality of virtual event action data as a function of the actual event profile. In some embodiments, plurality of virtual event action data may be associated with a plurality of initial virtual event elements. This may be implemented, without limitation, as described above in reference to FIGS. 1-5.

With continued reference to FIG. 6, method 600 includes a step 610 of receiving, by the at least a processor, an actual action datum related to an entity, without limitation, as described above in reference to FIGS. 1-5. In some embodiments, actual action datum may be received from an actual event participated by the entity. In some embodiments, actual action datum may include an actual action product. This may be implemented, without limitation, as described above in reference to FIGS. 1-5.

With continued reference to FIG. 6, method 600 includes a step 615 of identifying, by the at least a processor, at least one virtual action datum from plurality of virtual action data as a function of the actual action datum. This may be implemented, without limitation, as described above in reference to FIGS. 1-5.

With continued reference to FIG. 6, method 600 includes a step 620 of generating, by the at least a processor, a virtual event element associated to the at least one virtual action datum as a function of the actual action datum. This may be implemented, without limitation, as described above in reference to FIGS. 1-5. In some embodiments, virtual event element may include a virtual event sub-element. In some embodiments, generating the virtual event element may include converting the actual action product to the virtual event element. In some embodiments, generating the virtual event element may include training a virtual event element machine-learning model using virtual event element training data, wherein the virtual event element training data comprises a plurality of actual action data as input correlated to a plurality of virtual event elements as output, and generating the plurality of virtual event components as a function of the virtual event component machine-learning model. This may be implemented, without limitation, as described above in reference to FIGS. 1-5.

With continued reference to FIG. 6, method 600 may further include a step of modifying, by the at least a processor, at least one initial virtual event element of the plurality of initial virtual event elements as a function of the generated virtual event element. This may be implemented, without limitation, as described above in reference to FIGS. 1-5.

With continued reference to FIG. 6, method 600 may further include a step displaying, by the at least a processor, the generated virtual event element to the entity through a display device. This may be implemented, without limitation, as described above in reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

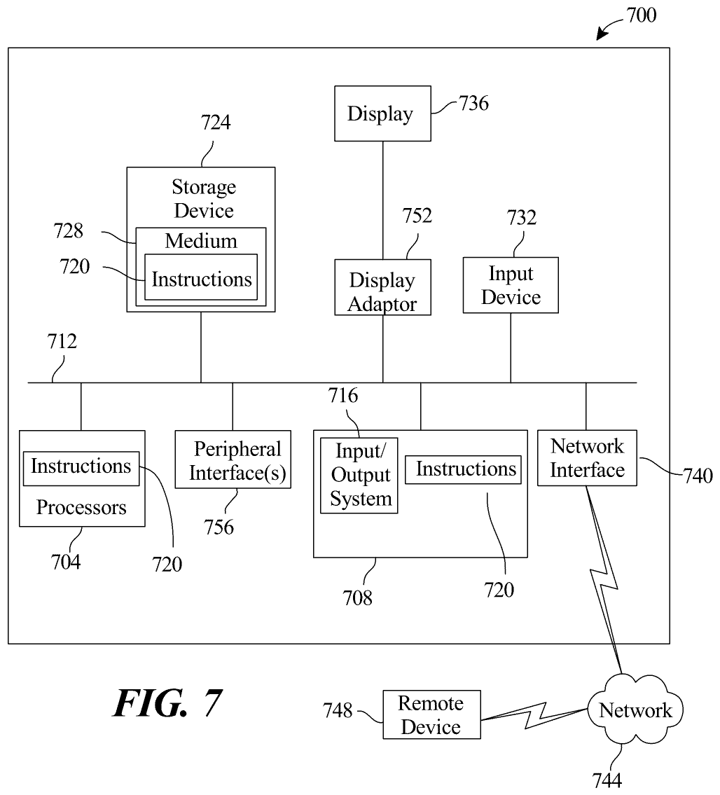

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus for virtual event element generation based on an actual action of an entity, the apparatus comprising:
at least a processor; and
a memory communicatively connected to the at least a processor, wherein the memory contains instructions configuring the at least a processor to:
generate a plurality of virtual action data;
receive an actual action datum related to an entity;
identify at least one virtual action datum from plurality of virtual action data as a function of the actual action datum; and
generate a virtual event element associated to the at least one virtual action datum as a function of the actual action datum.

2. The apparatus of claim 1, wherein generating the plurality of virtual action data comprises:
receiving an actual event profile; and
generating the plurality of virtual action data as a function of the actual event profile.

3. The apparatus of claim 1, wherein plurality of virtual action data is associated with plurality of initial virtual event elements.

4. The apparatus of claim 1, wherein the actual action datum is received from an actual event participated by the entity.

5. The apparatus of claim 1, wherein the actual action datum comprises an actual action product.

6. The apparatus of claim 1, wherein the virtual event element comprises a virtual event sub-element.

7. The apparatus of claim 5, wherein generating the virtual event element comprises:
converting the actual action product to the virtual event element.

8. The apparatus of claim 1, wherein generating the virtual event element comprises:
training a virtual event element machine-learning model using virtual event element training data, wherein the virtual event element training data comprises a plurality of actual action data as input correlated to a plurality of virtual event elements as output; and
generating the plurality of virtual event components as a function of the virtual event component machine-learning model.

9. The apparatus of claim 3, wherein the memory contains instructions further configuring the at least a processor to:
modify at least one initial virtual event element of the plurality of initial virtual event elements as a function of the generated virtual event element.

10. The apparatus of claim 1, wherein the memory contains instructions further configuring the at least a processor to:
display the generated virtual event element to the entity through a display device.

11. A method for a virtual event element generation based on an actual action of an entity, the method comprising:
generating, by at least a processor, a plurality of virtual action data;
receiving, by the at least a processor, an actual action datum related to an entity;
identifying, by the at least a processor, at least one virtual action datum from plurality of virtual action data as a function of the actual action datum; and
generating, by the at least a processor, a virtual event element associated to the at least one virtual action datum as a function of the actual action datum.

12. The method of claim 11, wherein generating the plurality of virtual action data comprises:
receiving an actual event profile; and
generating the plurality of virtual action data as a function of the actual event profile.

13. The method of claim 11, wherein the plurality of virtual action data is associated to a plurality of initial virtual event elements.

14. The method of claim 11, wherein the actual action datum is received from an actual event participated by the entity.

15. The method of claim 11, wherein the actual action datum comprises an actual action product.

16. The method of claim 11, wherein the virtual event element comprises a virtual event sub-element.

17. The method of claim 15, wherein generating the virtual event element comprises:
converting the actual action product to the virtual event element.

18. The method of claim 11, wherein generating the virtual event element comprises:
training a virtual event element machine-learning model using virtual event element training data, wherein the virtual event element training data comprises a plurality of actual action data as input correlated to a plurality of virtual event elements as output; and
generating the plurality of virtual event components as a function of the virtual event component machine-learning model.

19. The method of claim 13, wherein the method further comprises a step of
modifying, by the at least a processor, at least one initial virtual event element of the plurality of initial virtual event elements as a function of the generated virtual event element.

20. The method of claim 11, wherein the method further comprises a step of:
displaying, by the at least a processor, the generated virtual event element to the entity through a display device.
